(19) United States
(12) Patent Application Publication
(10) Pub. No.: US 2010/0238594 A1
(43) Pub. Date: Sep. 23, 2010

(54) HEAD SUSPENSION ASSEMBLY AND STORAGE DEVICE

(75) Inventors: Kenzo NAKAMURA, Ome-shi (JP); Shinji KOGANEZAWA, Atsugi-shi (JP); Takuma KIDO, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/727,080

(22) Filed: Mar. 18, 2010

(30) Foreign Application Priority Data
Mar. 19, 2009 (JP) 2009-067372

(51) Int. Cl. G11B 5/48

(52) U.S. Cl. 360/246.1; G9B/5.147

(57) ABSTRACT

According to one embodiment, a head suspension assembly includes: a metal thin plate held by a head suspension; a fixed plate formed in the metal thin plate and joined to the head suspension; a supporting plate formed in the metal thin plate on the front side of the fixed plate and supporting a head slider on a surface thereof and held on a rear surface thereof by a protrusion formed on the head suspension; an arm formed in the metal thin plate and extending from the fixed plate to the supporting plate and allowing a change in a posture of the supporting plate; an insulating layer extending from the fixed plate to the supporting plate and supported by the arm; a wiring pattern formed on the insulating layer; and a visco-elastic body arranged on a flat surface formed on the arm, the insulating layer, or the wiring pattern.

### CROSS-REFERENCE TO RELATED APPLICATIONS

This application is based upon and claims the benefit of priority from Japanese Patent Application No. 2009-067372, filed Mar. 19, 2009, the entire contents of which are incorporated herein by reference.

### BACKGROUND

1. Field

One embodiment of the invention relates to a head suspension assembly that is incorporated into a storage device such as a hard disk drive (HDD).

2. Description of the Related Art

A head suspension is attached to a top edge of a carriage arm incorporated into a HDD. A flexure is bonded to a surface of the head suspension. The flexure includes a metal thin plate. The metal thin plate includes a fixed plate joined to the surface of the head suspension, and a supporting plate integrally formed with the fixed plate and held by a protrusion formed on the head suspension. A head slider is supported on a surface of the supporting plate. An insulating layer is formed on the metal thin plate. A wiring pattern is formed on the insulating layer.

As a rotating speed of a magnetic disk becomes higher, a flow rate of air flow generated along a surface of the magnetic disk also becomes higher. When this air flow acts on the head suspension, the flexure vibrates. The vibration degrades a positioning accuracy of the head slider. In order to damp the vibration of the flexure, a damping material is bonded to a surface of the flexure on the head suspension. The damping material includes a visco-elastic body bonded to the surface of the flexure and a restraining member bonded onto the visco-elastic body. By the damping material, the vibration of the flexure is reduced.

Conventional technology is disclosed in Japanese Patent Application Publication (KOKAI) No. 2006-221726, Japanese Patent Application Publication (KOKAI) No. 2007-26575, Japanese Patent No. 414-4196, Japanese Patent No. 414-4197, Japanese Patent No. 414-4198, Japanese Patent No. 414-4199, Japanese Patent No. 3255660, Japanese Patent No. 2739927, and Japanese Patent Application Publication (KOKAI) No. H11-185415.

The damping material is bonded to the surface of the flexure. As described above, an insulating layer and a wiring pattern are formed on the metal thin plate of the flexure. Therefore, a step is formed between the insulating layer and the metal thin plate. Likewise, a step is formed between the wiring pattern and the insulating layer. Because of the step, the visco-elastic body cannot be in close contact with the flexure. The visco-elastic body partially floats or is separated from the flexure. As a result, a damping effect of the damping material fluctuates.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic plan view of a storage device according to an embodiment of the invention;

FIG. 2 is an exemplary schematic plan view of a head suspension assembly in the embodiment;

FIG. 3 is an exemplary schematic partially enlarged plan view of the head suspension assembly in the embodiment;

FIG. 4 is an exemplary schematic partially enlarged back view of the head suspension assembly in the embodiment;

FIG. 5 is an exemplary cross-sectional view taken along line 5-5 of FIG. 3;

FIG. 6 is an exemplary schematic side view of a head suspension assembly in the embodiment;

FIG. 7 is an exemplary schematic partially enlarged back view of a hinge plate in the embodiment;

FIG. 8 is an exemplary schematic partially enlarged plan view of a head suspension assembly according to another embodiment of the invention;

FIG. 9 is an exemplary schematic partially enlarged back view of the head suspension assembly in the embodiment;

FIG. 10 is an exemplary schematic partially enlarged back view of a head suspension assembly according to still another embodiment of the invention;

FIG. 11 is an exemplary schematic partially enlarged plan view of a head suspension assembly according to still another embodiment of the invention;

FIG. 12 is an exemplary schematic partially enlarged back view of the head suspension assembly in the embodiment;

FIG. 13 is an exemplary schematic plan view of a head suspension assembly according to still another embodiment of the invention;

FIG. 14 is an exemplary schematic partially enlarged side view of the head suspension assembly in the embodiment;

FIG. 15 is an exemplary schematic plan view of a head suspension assembly according to still another embodiment of the invention; and

FIG. 16 is an exemplary schematic partially enlarged side view of the head suspension assembly in the embodiment;

### DETAILED DESCRIPTION

Various embodiments according to the invention will be described hereinafter with reference to the accompanying drawings. In general, according to one embodiment of the invention, a head suspension assembly includes: a head suspension; a metal thin plate held by a surface of the head suspension; an insulating layer; a wiring pattern formed on a surface of the insulating layer; and a visco-elastic body, wherein the metal thin plate includes: a fixed plate joined to the surface of the head suspension; a supporting plate formed at a location on the front side of the fixed plate and configured to support a head slider on a front surface of the supporting plate and held on a rear surface of the supporting plate by a protrusion formed on the head suspension; and an arm extending from a front edge of the fixed plate to the supporting plate and configured to allow a change in a posture of the supporting plate, and wherein the insulating layer extends from the fixed plate to the supporting plate and is at least partially supported by the arm, and wherein the visco-elastic body is arranged on a flat surface formed on one of the arm, the insulating layer, and the wiring pattern.

According to another embodiment of the invention, a storage device comprising: a head suspension assembly, wherein the head suspension assembly includes: a head suspension; a metal thin plate held by a surface of the head suspension; an insulating layer; a wiring pattern formed on a surface of the insulating layer; and a visco-elastic body, wherein the metal thin plate has: a fixed plate joined to the surface of the head suspension; a supporting plate formed at a location on the front side of the fixed plate and configured to support a head slider on a front surface of the supporting plate and held on a rear surface of the supporting plate by a protrusion formed on the head suspension; and an arm extending from a front edge of the fixed plate to the supporting plate and configured to allow a change in a posture of the supporting plate, and wherein the insulating layer extends from the fixed plate to the supporting plate and is at least partially supported by the arm, and wherein the visco-elastic body is arranged on a flat surface formed on one of the arm, the insulating layer, and the wiring pattern.

According to still another embodiment of the invention, a head suspension assembly includes a base plate; a load beam arranged forward of the base plate at a predetermined distance from the base plate; a hinge plate coupling the base plate to load beam and including an elastic deformation portion arranged between the base plate and the load beam; and a visco-elastic body, wherein the elastic deformation portion has: a front-side region being flat and configured to be bent along a ridge line orthogonal to a longitudinal center line of the base plate, the front-side region being formed on a front side of the ridge line in the elastic deformation portion; a rear-side region being flat and formed on a rear side of the ridge line in the elastic deformation portion, and wherein the visco-elastic body is pasted to one of the front-side region and the rear-side region.

According to still another embodiment of the invention, a storage device includes a head suspension assembly, wherein the head suspension assembly includes: a base plate; a load beam arranged forward of the base plate at a predetermined distance from the base plate; a hinge plate coupling the base plate to load beam and including an elastic deformation portion arranged between the base plate and the load beam; and a visco-elastic body, wherein the elastic deformation portion has: a front-side region being flat and configured to be bent along a ridge line orthogonal to a longitudinal center line of the base plate, the front-side region being formed on a front side of the ridge line in the elastic deformation portion; a rear-side region being flat and formed on a rear side of the ridge line in the elastic deformation portion, and wherein the visco-elastic body is pasted to one of the front-side region and the rear-side region.

Various embodiments according to the invention will be described hereinafter with reference to the accompanying drawings.

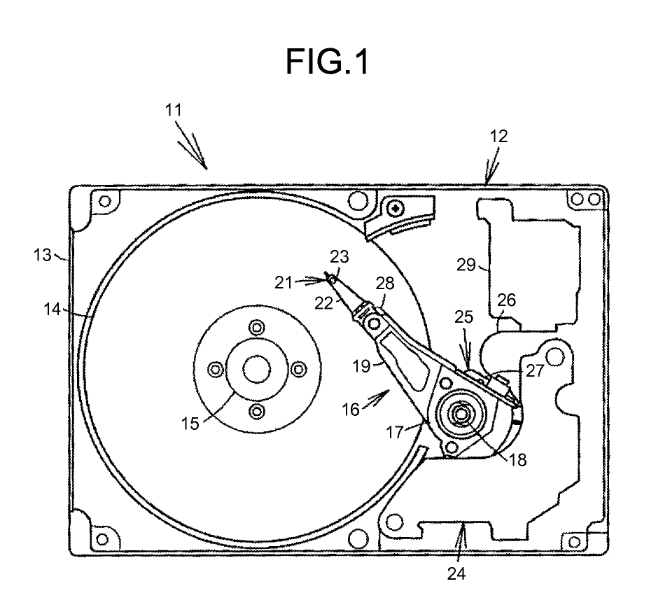

First, an inside configuration of a storage device according to one embodiment of the invention will be described. FIG. 1 schematically illustrates the inside configuration of the storage device according to the first embodiment of the invention. A hard disk drive device (HDD) is a specific example of the storage device. The HDD 11 includes a housing 12. The housing 12 is composed of a box-shaped base 13 and a cover (not illustrated). The base 13 defines, for example, a flat, rectangular parallelepiped internal space, or storage space. The base 13 may be formed by casting of a metal material such as aluminum. The cover is connected to an opening of the base 13. The storage space between the cover and the base 13 is enclosed. The cover may be formed of one plate material by press working, for example.

In the storage space, at least one magnetic disk 14 is stored as a storage medium. The magnetic disk 14 is mounted on a drive shaft of a spindle motor 15. The spindle motor 15 can rotate the magnetic disk 14 at a high speed such as 5,400 rpm, 7,200 rpm, 10,000 rpm, and 15,000 rpm. For example, the magnetic disk 14 is configured as a vertical magnetic recording disk. That is to say, an easy axis of magnetization in a recording magnetic film of the magnetic disk 14 is set in a direction orthogonal to a surface of the magnetic disk 14.

In the storage space, a carriage 16 is also stored. The carriage 16 includes a carriage block 17. The carriage block 17 is rotatably connected to a support shaft 18 extending in the vertical direction. In the carriage block 17, a plurality of carriage arms 19 are arranged extending horizontally from the support shaft 18. The carriage block 17 may be formed of aluminum by extrusion molding, for example.

A head suspension assembly 21 is attached to a top end of each carriage arm 19. The head suspension assembly 21 includes a head suspension 22 attached to a top end of the carriage arm 19. The head suspension 22 extends forward from the top end of the carriage arm 19. As described later, a flexure is attached to a top end of the head suspension 22. A posture of a flying head slider 23 can be changed with respect to the head suspension 22 by an action of the flexure. Ahead element, or an electromagnetic conversion element, is mounted on the flying head slider 23.

When air flow is generated on a surface of the magnetic disk 14 by rotation of the magnetic disk 14, a positive pressure, or a buoyant force, and a negative pressure are applied to the flying head slider 23 by an action of the air flow. When the buoyant force and the negative pressure are balanced with a pressing force of the head suspension 22, the flying head slider 23 can be flying with relatively high rigidity during rotation of the magnetic disk 14.

A power source such as a voice coil motor (VCM) 24 is connected to the carriage block 17. The carriage block 17 can be rotated around the support shaft 18 by the VCM 24. Swing motions of the carriage arm 19 and the head suspension 22 are realized based on the rotation of the carriage block 17.

As illustrated in FIG. 1, a flexible printed circuit board unit 25 is arranged on the carriage block 17. The flexible printed circuit board unit 25 includes a head IC (integrated circuit) 27 mounted on a flexible printed circuit board 26. The head IC 27 is connected to a read element and a write element of the electromagnetic conversion element. A flexure 28 is used to connect the head IC 27 to the read element and the write element. The flexure 28 is connected to the flexible printed circuit board unit 25.

When magnetic information or binary information is read, a sense current is provided from the head IC 27 to the read element of the electromagnetic conversion element. In a similar way, when binary information is written, a write current is provided from the head IC 27 to the write element of the electromagnetic conversion element. A voltage value of the sense current is set to a specific value. A current is provided to the head IC 27 from a small-sized circuit board 29 arranged in the storage space and a printed circuit board (not illustrated) attached to a bottom surface of a bottom plate of the base 13.

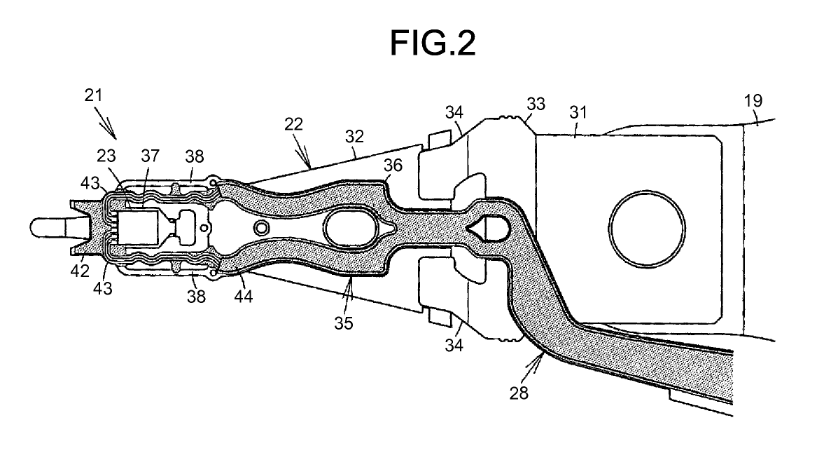

FIG. 2 schematically illustrates the structure of the head suspension assembly 21 according to the first embodiment of the invention. The head suspension 22 includes a base plate 31 attached to a front edge of the carriage arm 19, and a load beam 32 arranged forward of the base plate 31 at a predetermined distance from the base plate 31. A hinge plate 33 is fixed to surfaces of the base plate 31 and the load beam 32. The hinge plate 33 defines an elastic deformation portion 34 between a front edge of the base plate 31 and a rear edge of the load beam 32. In this manner, the hinge plate 33 couples the base plate 31 to the load beam 32. Each of the base plate 31, the load beam 32, and the hinge plate 33 is formed from a stainless steel plate, for example.

The above mentioned flexure 28 is bonded to a surface of the head suspension 22. The flexure 28 includes a metal thin plate 35. The metal thin plate 35 includes a fixed plate 36 partially joined to the surfaces of the load beam 32 and the hinge plate 33, and a supporting plate 37 supporting a rear surface of the flying head slider 23 with a surface of the supporting plate 37. The rear surface of the supporting plate 37 faces the surface of the load beam 32 at a location on a front side of the fixed plate 36. The rear surface of the supporting plate 37 is not joined to the surface of the load beam 32. The flying head slider 23 is bonded to a front surface of the supporting plate 37. In the joining of the fixed plate 36, spot welding is performed at a plurality of spot positions of the fixed plate 36, for example.

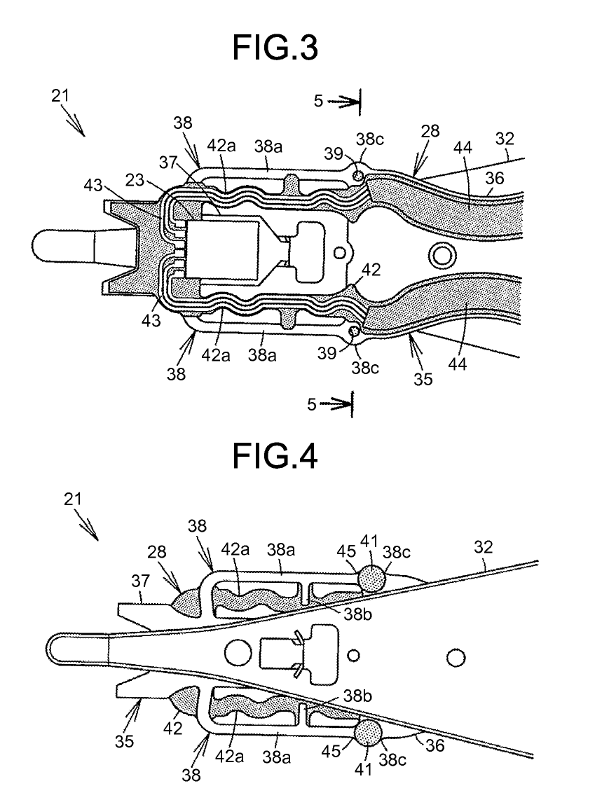

As illustrated in FIG. 3, the metal thin plate 35 includes a pair of arms 38 respectively extending along both side edges of the supporting plate 37. The supporting plate 37 is arranged between the arms 38. The arms 38 are located outside of an outline of the load beam 32. As illustrated in FIG. 4, the arm 38 includes an arm portion 38a extending from a base edge of the arm 38 connected to a front edge of the fixed plate 36 to a top edge of the arm 38 connected to the side edge of the supporting plate 37. A protruding portion 38b protruding toward the supporting plate 37 is formed on an inner periphery of the arm portion 38a between the base edge and the top edge of the arm 38.

An expanded portion 38c that is wider than the arm portion 38a is formed at the base edge of the arm portion 38a. The expanded portion 38c is formed in a round shape, for example. The expanded portion 38c is placed at a location corresponding to a loop of a vibration generated in the metal thin plate 35. A positioning hole 39 is formed in the expanded portion 38c. The positioning hole 39 is formed in a round shape, for example. A damper member 41 is bonded to a rear surface of the expanded portion 38c outside the outline of the load beam 32. The positioning hole 39 is used to determine a mounting position of the damper member 41. In the metal thin plate 35, the fixed plate 36, the supporting plate 37, and the arms 38 are formed from a single stainless steel plate.

The flexure 28 includes an insulating layer 42 formed on a surface of the metal thin plate 35. The insulating layer 42 extends from a surface of the fixed plate 36 to the surface of the supporting plate 37. The insulating layer 42 is made of an insulating material such as polyimide resin. The insulating layer 42 includes two lines of aerial portions 42a, 42a. The supporting plate 37 is placed between the aerial portions 42a, 42a. Each of the aerial portions 42a, 42a is placed outside the arm 38 between the fixed plate 36 and the supporting plate 37, and do not overlap with the arm 38. Apart of the aerial portion 42a is located outside the outline of the load beam 32. The aerial portions 42a are at least partially supported by the protruding portions 38b of the arms 38, respectively.

A plurality of lines of wiring patterns 43 are formed on a surface of the insulating layer 42. The wiring patterns 43 extend parallel to each other. The wiring patterns 43 are made of a conductive material such as copper. One end of each of the wiring pattern 43 is connected to the flying head slider 23. The other end of each of the wiring pattern 43 is connected to the flexible printed board 26. With the wiring patterns 43, the sense current and the write current are supplied from the head IC 27 to the flying head slider 23. A protecting layer 44 covers the wiring patterns 43 on the fixed plate 36. The protecting layer 44 is made of an insulating material such as polyimide resin.

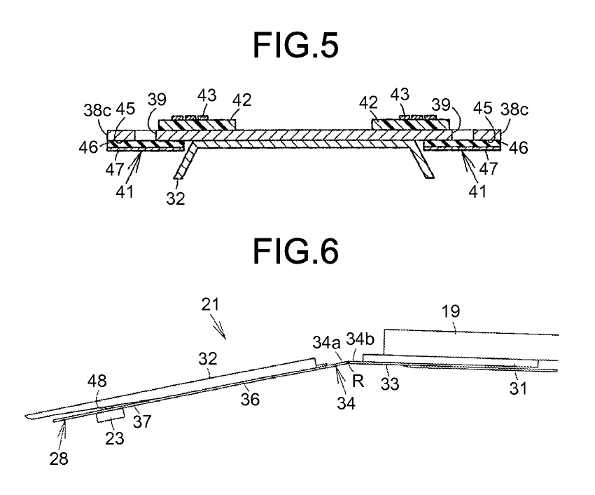

As illustrated in FIG. 5, a flat surface 45 is formed on the rear surface of each of the expanded portions 38c. The above described damper members 41 are bonded to the flat surfaces 45. Each of the damper members 41 includes a visco-elastic body 46 and a restraining member or a restraining plate 47. The visco-elastic body 46 is formed in a round shape and is bonded to the flat surface 45. The restraining plate 47 is formed in a round shape and is bonded onto the visco-elastic body 46. The centers of the restraining plates 47 coincide with the centers of the positioning holes 39, respectively. Each of the visco-elastic body 46 is sandwiched between the restraining plate 47 and the flat surface 45. The visco-elastic body 46 is made of Visco Elastic Material (VEM), for example. The restraining plate 47 is formed from a stainless steel plate or a polyimide resin plate, for example. An adhesive is used to bond the visco-elastic bodies 46 to the restraining plates 47.

A diameter of the damper member 41 is set at 300 μm or more, for example. A thickness of the visco-elastic body 46 is set between 25 μm and 50 μm, for example. A thickness of the restraining plate 47 is set between 25 μm and 50 μm, for example. Accordingly, a thickness of the damper member 41 is set between 50 μm and 100 μm, for example. On the other hand, a width of the arm portion 38a is set at approximately 100 μm, for example. A The diameter of the expanded portion 38c can be set depending on the diameter of the damper members 41.

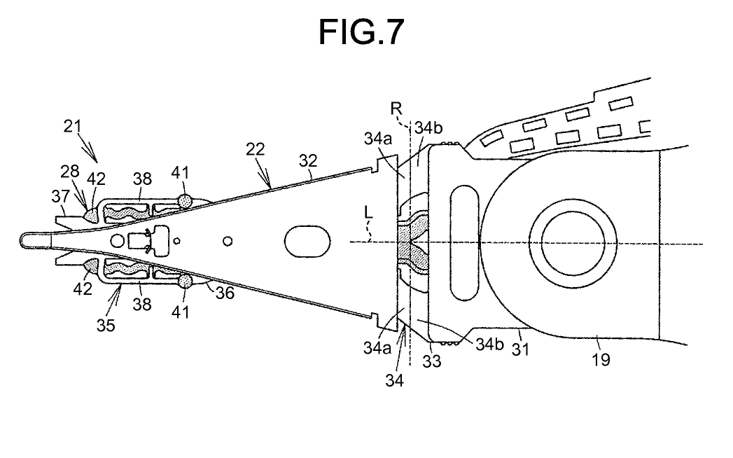

As illustrated in FIG. 6, the supporting plate 37 is received by a dome-like protrusion 48 formed on the surface of the load beam 32 at a back side of the flying head slider 23. Because the supporting plate 37 is supported by the arms 38, 38, a change in a posture of the supporting plate 37 or the flying head slider 23 on the protrusion 48 is allowed in accordance with deformation of the arms 38, 38. As illustrated in FIG. 7, the hinge plate 33 is bent at the elastic deformation portion 34 along a ridge line R orthogonal to the longitudinal center line L of the base plate 31. The elastic deformation portion 34 has a front-side region 34a formed on a front side of the ridge line R in the elastic deformation portion 34, and a rear-side region 34b formed on a rear side of the ridge line R in the elastic deformation portion 34. The hinge plate 33 unfolds evenly in the front-side region 34a and the rear-side region 34b. The front-side region 34a unfolds parallel to the load beam 32. The rear-side region 34b unfolds parallel to the base plate 31.

The hinge plate 33 produces predetermined elasticity or bending force based on the bending of the elastic deformation portion 34 along the ridge line R. By the bending force, pressing force acting toward the surface of the magnetic disk 14 is applied to a front edge of the load beam 32. The pressing force acts on the flying head slider 23 from behind the supporting plate 37 by the protrusion 48. A posture of the flying head slider 23 can be changed based on the buoyant force produced by the air flow. In this time, the arms 38 are deformed depending on the change in the posture of the supporting plate 37, as described above. At the same time, the aerial portions 42a of the insulating layer 42 are deformed.

In the above described HDD 11, the air flow is generated along the surface of the magnetic disk 14 while the magnetic disk 14 is rotating. To position the electromagnetic conversion element mounted on the flying head slider 23, the head suspension assembly 21 is placed on the magnetic disk 14. The air flow acts on the arms 38. The damper members 41 are bonded to the base edges of the arms 38. The arm 38 functions as a base member. As a result, vibration of the arm 38 or the flexure 28 is suppressed. Further, because the damper members 41 are bonded to the flat surfaces 45 on the arms 38, the visco-elastic bodies 46 are in close contact with the arms 38. No spaces are left between the visco-elastic bodies 46 and the arms 38. The damper members 41 produce a large damping effect. The electromagnetic conversion element is positioned above a target recording track with high precision. Accordingly, binary information is written and read with high precision.

Next, a manufacturing method of the head suspension assembly 21 is described. First, the head suspension 22 is assembled. In the meantime, the flexure 28 is assembled. The flexure 28 is joined to a predetermined position of the surface of the head suspension 22. In the joining, spot welding is performed. After the joining, the surface of the metal thin plate 35 is supported by a front side of the head suspension 22. Because the surface of the metal thin plate 35 has a relatively large area, the metal thin plate 35 is supported with relative ease. A robot to supply the damper members 41 (not illustrated) positions a center of the damper member 41 to the center of positioning hole 39 from a rear side of the metal thin plate 35. In this manner, the robot bonds the damper members 41 onto the flat surfaces 45. After that, the flying head slider 23 is bonded to the surface of the supporting plate 37.

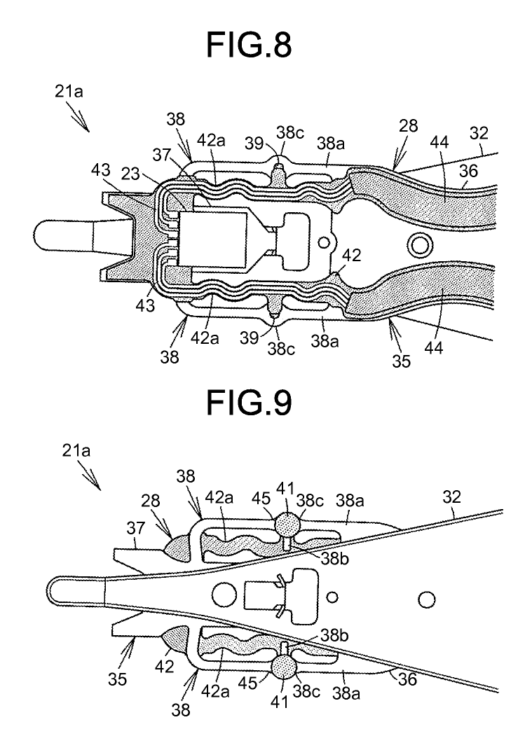

FIG. 8 schematically illustrates a structure of a head suspension assembly 21a according to a second embodiment of the invention. In the head suspension assembly 21a, the expanded portions 38c are formed adjacent to the protruding portions 38b on the arm portions 38a. As described above, the expanded portion 38c is placed at a location corresponding to the loop of the vibration generated in the metal thin plate 35. As illustrated in FIG. 9, the flat surfaces 45 are formed on the rear surfaces of the expanded portions 38c. The damper members 41 are bonded to the flat surfaces 45, respectively. The same or equivalent components and structures as those in the head suspension assembly 21 of the first embodiment are denoted by the same reference numerals as those used in the first embodiment. According to this head suspension assembly 21a, the similar operations and effects can be achieved to those achieved by the first embodiment.

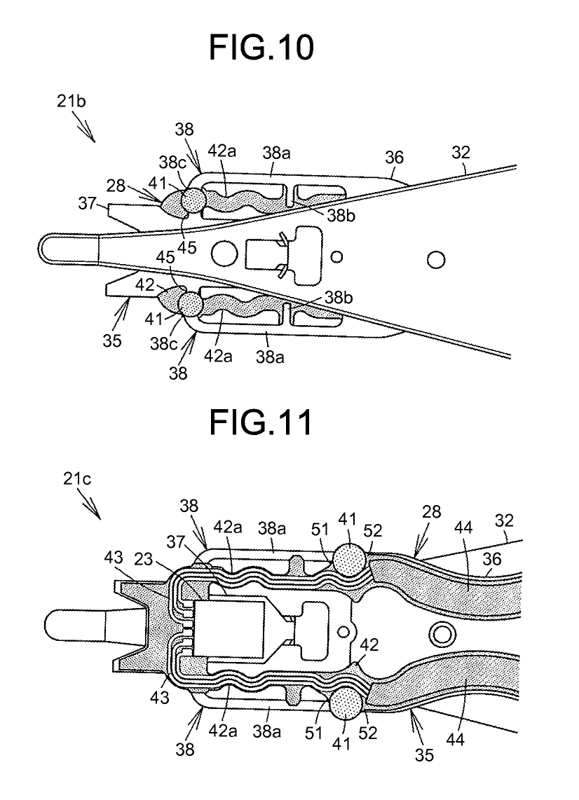

FIG. 10 schematically illustrates a structure of a head suspension assembly 21b according to a third embodiment of the invention. In the head suspension assembly 21b, the expanded portions 38c are placed at top edges of the arm portions 38a. As described above, the expanded portion 38c is placed at the location corresponding to the loop of the vibration generated in the metal thin plate 35. The flat surfaces 45 are formed on the rear surfaces of the expanded portions 38c. The damper members 41 are bonded to the flat surfaces 45, respectively. The same or equivalent components and structures as those in the head suspension assembly 21 of the first embodiment are denoted by the same reference numerals as those used in the first embodiment. According to this head suspension assembly 21b, the similar operations and effects can be achieved to those achieved by the first embodiment.

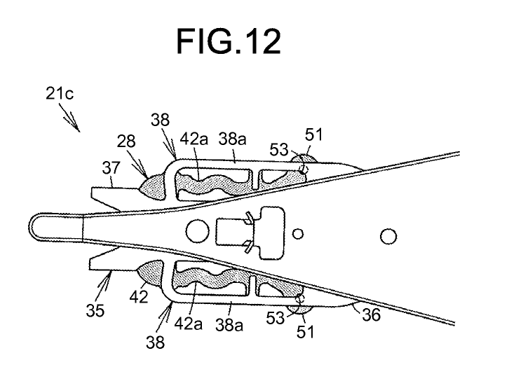

FIG. 11 schematically illustrates a structure of a head suspension assembly 21c according to a fourth embodiment of the invention. In the head suspension assembly 21c, expanded portions 51 are formed on the insulating layer 42. Flat surfaces 52 are formed on front surfaces of the expanded portions 51, respectively. The expanded portions 51 are placed outside the outline of the load beam 32. The damper members 41 are bonded to the flat surfaces 52, respectively. The expanded portion 51 is placed at a location corresponding to a loop of a vibration generated in the insulating layer 42. As illustrated in FIG. 12, positioning holes 53 are formed in the insulating layer 42. Centers of the positioning holes 53 coincide with the centers of the damper members 41, respectively. Rear surfaces of the expanded portions 51 are supported by the arms 38, respectively. The same or equivalent components and structures as those in the head suspension assembly 21 of the first embodiment are denoted by the same reference numerals as those used in the first embodiment. According to this head suspension assembly 21c, the similar operations and effects can be achieved to those achieved by the first embodiment.

To manufacture the head suspension assembly 21c, the flexure 28 is joined to the surface of the head suspension 22, as in the first embodiment. After the joining, the arms 38 and the expanded portions 51 are supported from a rear side of the head suspension 22 outside the outline of the load beam 32. A robot to supply the damper members 41 positions a center of the damper member 41 to the center of positioning hole 53 from a rear side of the insulating layer 42. In this manner, the robot bonds the damper members 41 onto the flat surfaces 52. After that, the flying head slider 23 is bonded to the surface of the supporting plate 37. In this manner, the head suspension assembly 21c is manufactured.

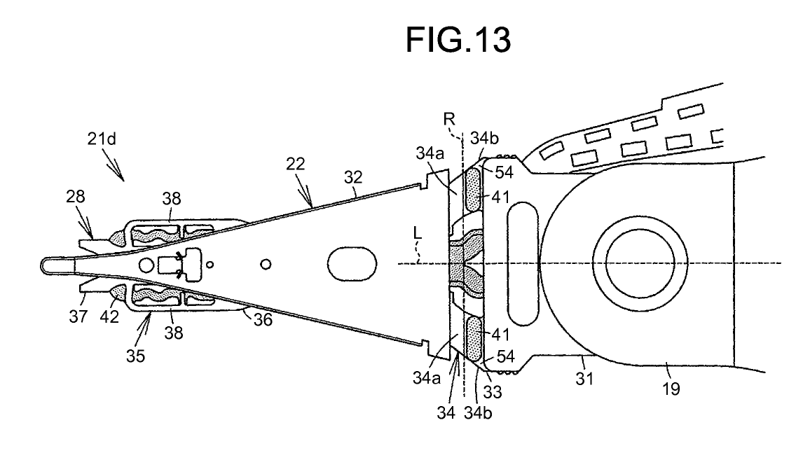

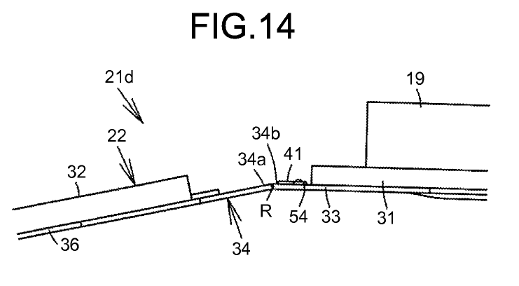

FIG. 13 schematically illustrates a structure of a head suspension assembly 21d according to a fifth embodiment of the invention. In this head suspension assembly 21d, the pair of damper members 41 are bonded to the rear-side region 34b of the elastic deformation portion 34 on a rear surface of the hinge plate 33. Each of the damper members 41 extends longitudinally in a direction orthogonal to the longitudinal center line L of the base plate 31, for example. As illustrated in FIG. 14, flat surfaces 54 are formed in the rear-side region 34b on the rear surface of the hinge plate 33. The damper members 41 are bonded to the flat surfaces 54, respectively. The same or equivalent components and structures as those in the head suspension assembly 21 of the first embodiment are denoted by the same reference numerals as those used in the first embodiment.

In the head suspension assembly 21d, the hinge plate 33 functions as a base member. As a result, vibration of the hinge plate 33 is suppressed. Further, because the damper members 41 are bonded to the flat surfaces 54 on the hinge plate 33, the visco-elastic bodies 46 are in close contact with the hinge plate 33. No spaces are left between the visco-elastic bodies 46 and the hinge plate 33. The damper members 41 produce a large damping effect. The electromagnetic conversion element is positioned above a target recording track with high precision. Accordingly, binary information is written and read with high precision.

Furthermore, the damper members 41 are bonded to the hinge plate 33 in the rear-side region 34b on a rear side of the ridge line R. The damper members 41 are not bonded onto the ridge line R. Accordingly, the elasticity or the bending force of the elastic deformation portion 34 does not change. The pressing force applied to the front edge of the load beam 32 does not change either. A floating posture of the flying head slider 23 is established as designed. Still furthermore, because the rear-side region 34b unfolds parallel to the base plate 31, the surface of the base plate 31 can be readily supported when the damper members 41 are bonded. Thus, the damper members 41 can be readily bonded to the rear surface of the hinge plate 33.

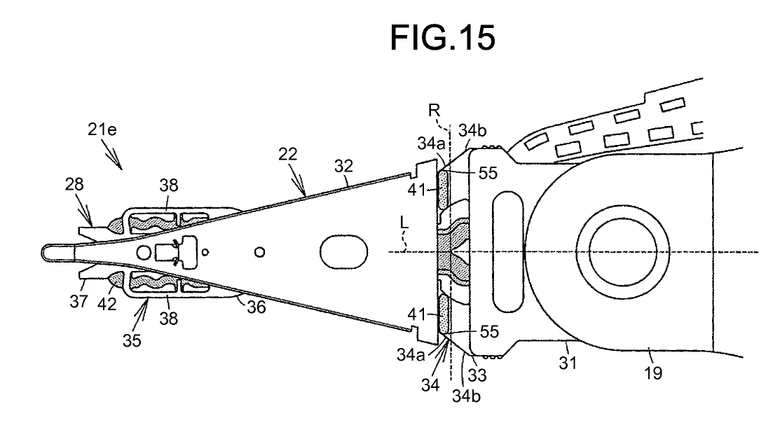

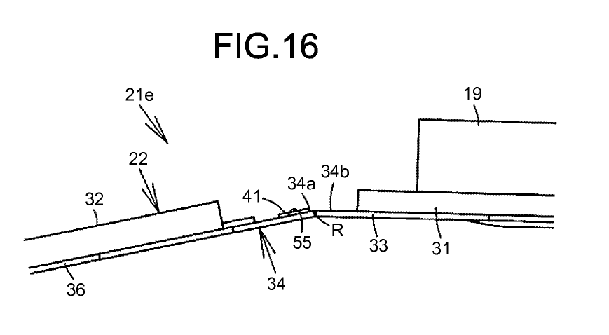

FIG. 15 schematically illustrates a structure of a head suspension assembly 21e according to a sixth embodiment of the invention. In this head suspension assembly 21e, the pair of damper members 41 are bonded to the front-side region 34a of the elastic deformation portion 34 on the rear surface of the hinge plate 33. As described in the fifth embodiment, each of the damper members 41 extends longitudinally in the direction orthogonal to the longitudinal center line L of the base plate 31, for example. As illustrated in FIG. 16, flat surfaces 55 are formed in the front-side region 34a on the hinge plate 33. The damper members 41 are bonded to the flat surfaces 55, respectively. The same or equivalent components and structures as those in the head suspension assembly 21 of the first embodiment are denoted by the same reference numerals as those used in the first embodiment. According to this head suspension assembly 21e, the similar operations and effects can be achieved to those achieved by the above described head suspension assembly 21d.

The above head suspension assemblies 21 to 21e may be combined with each other. For example, while being bonded onto the flexure 28, the damper members 41 may be bonded onto the hinge plate 33. Flat surfaces may be formed on the wiring patterns 42. The damper members 41 may be bonded to the flat surfaces formed on the wiring patterns 42. The shape of each of the damper members 41 is a round but is not limited thereto. The shape of each of the damper members 41 may be a rectangle, for example. Such rectangular damper members 41 may be bonded to flat surfaces formed on the arm portions 38a, for example.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A head suspension assembly comprising:
a head suspension comprising a metal plate on a surface of the head suspension;
an insulating layer comprising a wiring pattern on a surface of the insulating layer; and
a visco-elastic body,
wherein the metal plate includes:
a fixed plate joined to the surface of the head suspension;
a supporting plate located on the front side of the fixed plate and configured to support a head slider on a front surface of the supporting plate and held on a rear surface of the supporting plate by a protrusion on the head suspension; and
an arm extending from a front edge of the fixed plate to the supporting plate and configured to allow a change in a posture of the supporting plate, and
wherein the insulating layer extends from the fixed plate to the supporting plate and is at least partially supported by the arm, and
wherein the visco-elastic body is arranged on a flat surface of either the arm, the insulating layer, or the wiring pattern.

2. The head suspension assembly of claim 1, further comprising:
a restraining member arranged on a surface of the visco-elastic body and configured to have the visco-elastic body interposed between the flat surface and the restraining member.

3. The head suspension assembly of claim 1, wherein the arm comprises an arm portion and an expanded portion where the flat surface is formed, the expanded portion being wider than the arm portion.

4. The head suspension assembly of claim 1, wherein the flat surface is located on a rear surface of the arm outside an outline of the head suspension.

5. The head suspension assembly of claim 1, further comprising:
a positioning hole formed in the flat surface and configured to be used to determine a mounting position of the visco-elastic body.

6. A storage device comprising:
a head suspension assembly comprising:
a head suspension comprising a metal plate on a surface of the head suspension;
an insulating layer comprising a wiring pattern on a surface of the insulating layer; and
a visco-elastic body,
wherein the metal plate comprises:
a fixed plate joined to the surface of the head suspension;
a supporting plate located on the front side of the fixed plate and configured to support a head slider on a front surface of the supporting plate and held on a rear surface of the supporting plate by a protrusion on the head suspension; and
an arm extending from a front edge of the fixed plate to the supporting plate and configured to allow a change in a posture of the supporting plate, and
wherein the insulating layer extends from the fixed plate to the supporting plate and is at least partially supported by the arm, and
wherein the visco-elastic body is arranged on a flat surface of either the arm, the insulating layer, or the wiring pattern.

7. A head suspension assembly comprising:
a base plate;
a load beam arranged forward of the base plate at a predetermined distance from the base plate;
a hinge plate coupling the base plate to the load beam and comprising an elastic deformation portion arranged between the base plate and the load beam; and
a visco-elastic body,
wherein the elastic deformation portion has:
a flat front-side region configured to be bent along a ridge line orthogonal to a longitudinal center line of the base plate, the flat front-side region formed on a front side of the ridge line in the elastic deformation portion;
a flat rear-side region formed on a rear side of the ridge line in the elastic deformation portion, and
wherein the visco-elastic body is attached to the front-side region or the rear-side region.

8. The head suspension assembly of claim 7, further comprising:
a restraining member arranged on a surface of the visco-elastic body and configured to have the visco-elastic body interposed between the hinge plate and the restraining member.

9. The head suspension assembly of claim 7, wherein the visco-elastic body is attached to a rear surface of the hinge plate.
